(19) United States
(12) Patent Application Publication
(10) Pub. No.: US 2025/0138778 A1
(43) Pub. Date: May 1, 2025

(54) SOUND LEAK MITIGATION FOR A PERSONAL LISTENING DEVICE

(71) Applicant: Motorola Mobility LLC, Chicago, IL (US)

(72) Inventors: Ranjeet Gupta, Naperville, IL (US); Ajit Kumar Panda, Vernon Hills, IL (US); Amit Kumar Agrawal, Bangalore (IN)

(73) Assignee: Motorola Mobility LLC, Chicago, IL (US)

(21) Appl. No.: 18/496,116

(22) Filed: Oct. 27, 2023

(51) Int. Cl. G06F 3/16; G10L 15/26; H04R 1/32

(52) U.S. Cl. CPC G06F 3/165; G10L 15/26; H04R 1/323; H04R 2430/01

(57) ABSTRACT

In aspects of sound leak mitigation for a personal listening device, an audio source device, such as a mobile device, can include a device interface to connect the audio source device to a personal listening device for audio playback. The audio source device implements a sound leak mitigation module that detects the personal listening device connected to the audio source device via the device interface and can determine that the personal listening device exhibits sound leakage during the audio playback. The sound leak mitigation module can mitigate the sound leakage from the personal listening device during the audio playback.

### BACKGROUND

Sound leakage is the unintended escape of sound from a personal listening device, such as headphones or earbuds, to an external environment. When a user is listening to audio using a personal listening device, it is inevitable that some of the audio will be heard by others nearby, even though the user is using headphones or earbuds. In many scenarios, sound leakage is merely a disturbance, such as when someone is listening to music on their headphones and the music can be heard by others nearby. However, sound leakage may also pose more serious consequences, such as when sound leakage occurs during a communication session (e.g., a voice call or audio/video meeting) in which confidential or personal information is discussed, and may be overheard by others nearby.

### BRIEF DESCRIPTION OF THE DRAWINGS

Implementations of the techniques for sound leak mitigation for a personal listening device are described with reference to the following Figures. The same numbers may be used throughout to reference like features and components shown in the Figures.

FIG. 1 illustrates an example system for sound leak mitigation for a personal listening device in accordance with one or more implementations as described herein.

FIG. 2 illustrates an example audio source device architecture for sound leak mitigation for a personal listening device in accordance with one or more implementations as described herein.

FIGS. 3 and 4 illustrate example methods for sound leak mitigation for a personal listening device in accordance with one or more implementations of the techniques described herein.

FIG. 5 illustrates various components of an example device that may be used to implement the techniques for sound leak mitigation for a personal listening device as described herein.

### DETAILED DESCRIPTION

Sound is produced by vibrations. In personal listening devices, such as headphones and earbuds, these vibrations are generated by one or more drivers, which are designed to convert electrical signals into audible sound. Personal listening devices are structured to direct the sound into a listener's ears. However, not all of this sound gets channeled directly into the listener's ears, and the sound that may be audible outside of a personal listening device is referred to as sound leakage.

There are several factors that contribute to sound leakage. The design of a personal listening device is often a major factor contributing to how effective the personal listening device is at reducing sound leakage. Open back headphones, for instance, are designed with perforations or grills in the ear cups to allow some sound to escape intentionally, giving listeners a more natural or spacious sound experience. Conversely, closed-back headphones aim to isolate the listener from external noise and reduce sound leakage but are not able to prevent it. Some personal listening devices incorporate noise cancellation technology that further isolates the listener from external noise that may affect the listening experience. This technology also does not prevent sound leakage. Other factors such as the fit and seal, volume capabilities, and build materials contribute to the sound leakage characteristics of headphones, earbuds, and other personal listening devices.

In some cases, sound leakage is a benign phenomenon and does not affect the listener's ability to hear sounds. Other people in the surrounding environment, however, may be disturbed by the sound leakage. For example, when one is listening to music in an otherwise quiet environment, such as a library, sound leakage may be more likely to disturb others. In other cases, sound leakage becomes a serious safety or privacy issue. For example, a listener may want to minimize sound leakage to avoid inadvertently sharing personal private information (e.g., medical records) or confidential business information (e.g., a new proprietary technology) during a communication session, such as during a voice call or an audio/video meeting. In these cases, the listener may want to move to a private location to participate in the communication session and avoid potential eavesdroppers, whether inadvertent or otherwise.

Some conventional technologies exist that aim to reduce sound leakage in personal listening devices. For example, artificial intelligence has been used to determine whether audio output by headphones should be treated as private. If so, the artificial intelligence instructs components of the headphones (e.g., specially designed acoustic transducers) to reduce the sound pressure so that the private audio cannot be heard by others within a reasonable distance of the listener. Although these technologies reduce sound leakage, the use of artificial intelligence can drastically reduce battery life for battery-powered devices, such as smartphones and tablets. The cost of implementing these technologies is high and that cost is passed on to the consumer. The adoption rate by device manufacturers is low as a result.

The concepts and technologies discussed herein provide sound leak mitigation for a personal listening device, such as headphones and earbuds. According to aspects described herein, an audio source device includes a sound leak mitigation module that enables the audio source device to mitigate sound leakage from personal listening devices. The audio source device can be a mobile phone, a smartphone, and/or any other type of device that is capable of generating audio for output through a personal listening device. More specifically, the sound leak mitigation module identifies the type of personal listening device being used and adjusts the audio output accordingly to minimize sound leakage. For example, the type of personal listening device may be an open back, semi-open back, bone conduction, in-ear, on-ear, or closed back type of headset, headphones, or earbuds, all of which have varying levels of sound leakage.

By determining the headset, headphone, or earbud type, the sound leak mitigation module can categorize the personal listening device into a sound leakage category, which can be as simple as “most leaky” or “least leaky,” or a more fine-grained categorization using a multi-point scale (e.g., 1-5 or 1-10). Other categorization techniques are contemplated, such as a letter-based scale (A, B, C, D, or F) or the like. In some implementations, the sound leak mitigation module can also selectively enable a live transcription function to compensate for any volume reduction by providing text that the user can read along with any audio that is being emitted. In this manner, the concepts and technologies described herein improve privacy and reduce disturbances caused by sound leakage from personal listening devices.

While features of the described techniques for sound leak mitigation for a personal listening device are implemented in any number of different devices, systems, environments, and/or configurations, implementations of the techniques for sound leak mitigation for a personal listening device are described in the context of the following example devices, systems, and methods.

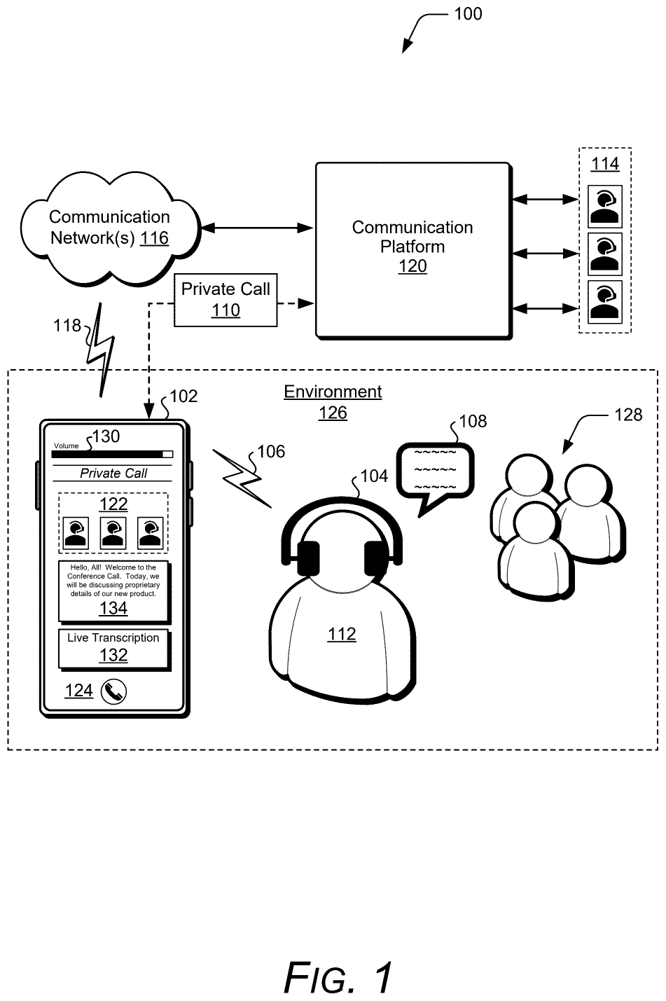

FIG. 1 illustrates an example system 100 for sound leak mitigation for a personal listening device, as described herein. The system 100 includes an audio source device 102 that is connected to a personal listening device 104, such as headphones or earbuds, via a wireless or wired connection (hereafter “connection” 106). The audio source device 102 provides audio 108 to the personal listening device 104 via the connection 106.

In the illustrated example, the audio 108 is associated with a private call 110 between a user 112, who is listening to the audio 108 via the personal listening device 104, and one or more other users 114. The audio 108, however, may be any type of audio, some examples of which include, but are not limited to, audio associated with music, talk radio, podcasts, lectures, presentations, movies, videos, and the like. The audio 108 may be live audio, such as audio exchanged between devices (e.g., mobile devices, wireless communication devices, and the like) of the user 112 and the other user(s) 114 during the private call 110, or pre-recorded audio, such as music. The audio 108 may be stored locally on the audio source device 102, streamed to the audio source device 102, or otherwise played by the audio source device 102 through the personal listening device 104 so that the user can hear the audio 108.

The audio source device 102 is shown as a touchscreen smartphone with minimal hardware buttons on the sides for power and volume control. The audio source device 102, however, can be or can include at least one of any type of a wireless device, mobile device, mobile phone, flip phone, client device, companion device, tablet, computing device, communication device, entertainment device, gaming device, media playback device, and/or any other type of computing, consumer, and/or electronic device. As such, the illustrated example of the audio source device 102 should not be construed as being limiting in any way.

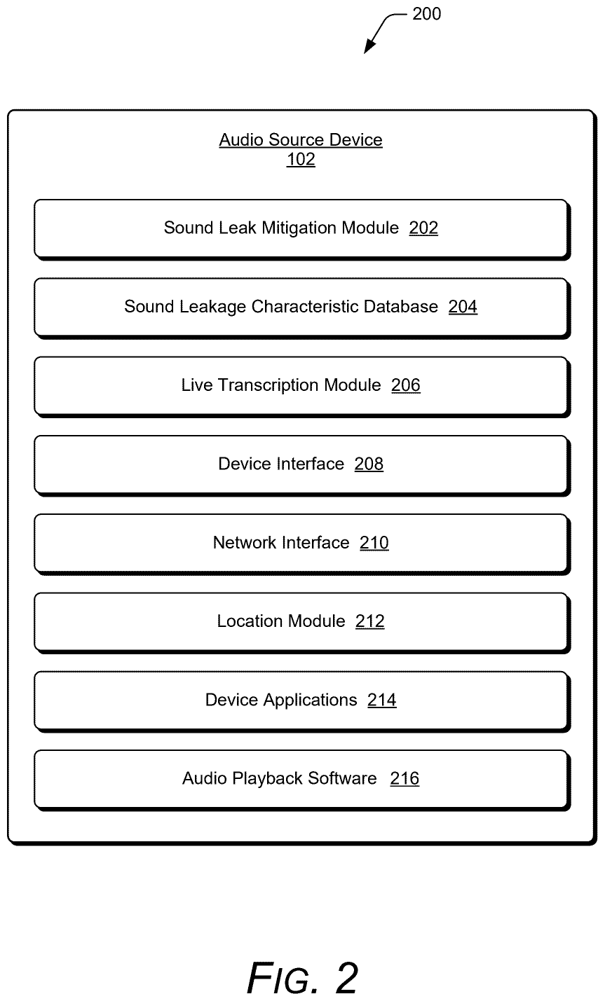

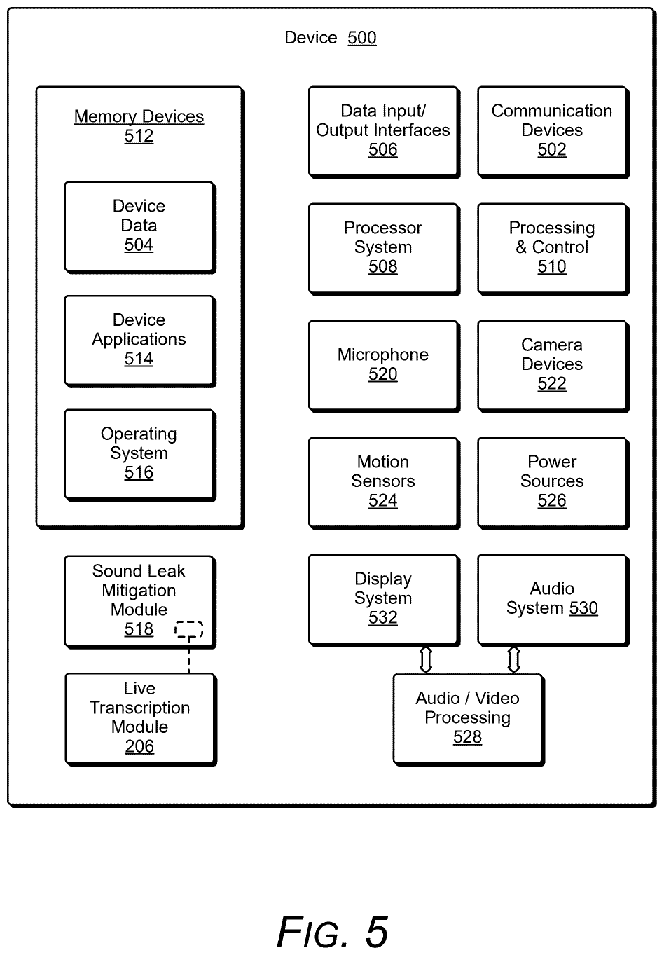

The audio source device 102 can be implemented with various components, such as a processor system and memory, as well as any number and combination of different components as further described with reference to the example audio source device architecture shown in FIG. 2 and the example device shown in FIG. 5. In implementations, the audio source device 102 includes various radios for wireless communication with other devices. For example, the audio source device 102 can include at least one of a BLUETOOTH® (BT) or BLUETOOTH® Low Energy (BLE) transceiver, a near field communication (NFC) transceiver, or the like. The connection 106, for example, can be a BT or BLE connection. In some cases, the audio source device 102 includes at least one of a WI-FI® radio, a cellular radio, a global positioning satellite (GPS) radio, or any available type of device communication interface. In the illustrated example, the audio source device 102 uses one or more of the aforementioned device communication interfaces to connect to and communicate with one or more communication networks 116 via a network connection 118.

In some implementations, the devices, applications, modules, servers, and/or services described herein communicate via the communication network 116, such as for data communication with the audio source device 102. For example, the audio source device 102 may receive, at least in part, the audio 108 via the communication network 116, such as part of the private call 110 served via the communication network. The communication network 116 includes a wired and/or a wireless network. The communication network 116 can be implemented using any type of network topology and/or communication protocol and is represented or otherwise implemented as a combination of two or more networks, to include IP-based networks, cellular networks, and/or the Internet. The communication network 116 can include one or more mobile operator networks that are managed by one or more mobile network operator and/or one or more other network operators, such as a communication service provider, mobile phone provider, and/or Internet service provider.

In the illustrated example, the audio source device 102 operates in communication with a communication platform 120 via the communication network 116. The communication platform 120 is or includes an audio communication platform, which may be provided, at least in part, by one or more of the aforementioned communication service providers. The communication platform 120 may be or may include a communication platform that operates independently of or as part of the communications network 116. For example, in some implementations, the communication platform 120 is a standalone voice-over-IP (VOIP) service that allows the user 112 to place and receive VOIP calls with others, such as the other users 114 (e.g., the audio source device 102 communicates with other communication devices via the communication platform 120).

The communication platform 120 additionally may provide video and/or interactive services. For example, the communication platform 120 may enable the private call 110 to be conducted as part of an audio/video meeting (e.g., a conference call with video), in which representative images 122 of the other users 114 can be presented on a display 124 of the audio source device 102. Similarly, a representative image of the user 112 can be presented on corresponding displays of devices (not shown) of the other users 114 during the private call 110. The representative images 122 can be static images, animated images (e.g., animated graphics interchange format (GIF) images), “live” video images (e.g., real-time or near real-time video), avatars, or the like. The communication platform 120 may provide additional services, such as chat, screen sharing, and the like.

In the illustrated example, the user 112 is listening to the audio 108 in an environment 126 that includes one or more other persons 128. The other persons 128 are within a reasonable distance from the user 112 and are able to hear at least some of the audio 108 being emitted to the user 112 through the personal listening device 104. The environment 126 is representative of any environment the user 112 may be located or positioned in while listening to the audio 108. Although the concepts and technologies disclosed herein are applicable to any environment 126, the concepts and technologies disclosed herein may find particular application to quiet environments, such as a library or a workplace, in which the audio 108 emitted by the personal listening device 104 may be more easily heard by the other persons 128. The other persons 128 may inadvertently eavesdrop on the user 112. At times, however, the other persons 128 may have malicious intent and try to steal private information (e.g., personal identifying information (PII), bank information, medical information, confidential business information, or the like) that is exchanged in the audio 108.

Typically, in situations such as those described above, the user 112 may manually reduce the volume of the audio output from the audio source device 102 in an attempt to reduce sound leakage from the personal listening device 104. However, manually reducing the volume of the audio output may result in the volume being too low for the user 112 to hear the audio 108, or alternatively, the volume being sufficient for the user 112 to hear the audio 108 but also sufficient for the other persons 128 to hear the audio 108 as well. It is often the case that the user 112 will be engaged in conversation or trying to listen intently to the audio 108 and may be unaware of the other persons 128 and their ability to hear the audio 108 due to the sound leakage from the personal listening device 104. Moreover, making volume adjustments on-the-fly may cause the user 112 to miss important information shared in the audio 108 while still inadvertently exposing the audio 108 to the other persons 128.

The illustrated display 124 presents a volume level indicator 130 to show the user 112 the current volume level of the output from the audio source device 102 and allow the user 112 to manually adjust the current volume level using the touchscreen functionality of the display 124 and/or volume buttons shown on the side of the audio source device 102. Some personal listening devices 104 may include a volume button or other mechanism (e.g., voice recognition) to allow manual adjustment of the volume.

In some implementations, the audio source device 102 can automatically reduce the volume level of the output from the audio source device 102 based upon a type of the personal listening device 104. Alternatively, or in addition, the audio source device 102 can provide a live transcription feature 132, which can be enabled automatically or selected by the user 112 on-demand to generate transcribed text 134 of the audio 108. This functionality allows the user 112 to continue hearing the audio 108 at a reduced volume to compensate for the sound leakage characteristics of the personal listening device 104. The additional functionality provided by the live transcription feature 132 allows the user 112 to read the transcribed text 134 to ensure the user 112 does not miss any information presented in the audio 108 while mitigating any sound leakage from the personal listening device 104. Additional details in this regard are shown and described below with reference to FIG. 2.

FIG. 2 illustrates an example sound leak mitigation architecture 200 of the audio source device 102 for mitigating sound leakage of a personal listening device 104 in accordance with one or more implementations as described herein. The sound leak mitigation architecture 200 includes various functionality that enables the audio source device 102 to implement different aspects of sound leak mitigation for a personal listening device 104.

The illustrated sound leak mitigation architecture 200 includes a sound leak mitigation module 202, a sound leakage characteristic database 204, and a live transcription module 206. The sound leak mitigation module 202, the sound leakage characteristic database 204, and/or the live transcription module 206 can be stored in a memory device and can be executed by one or more processors to cause the audio source device 102 to perform operations. An example memory device and processor system are shown and described with reference to FIG. 5.

As shown in the illustrated example, the sound leak mitigation module 202, the sound leakage characteristic database 204, and the live transcription module 206 represent functionality (e.g., logic, software, and/or hardware) enabling aspects of the described techniques for sound leak mitigation for a personal listening device. The sound leak mitigation module 202, the sound leakage characteristic database 204, and the live transcription module 206 can be implemented as computer instructions stored on computer-readable storage media and can be executed by a processor system of the audio source device 102. Alternatively, or in addition, the sound leak mitigation module 202, the sound leakage characteristic database 204, and/or the live transcription module 206 can be implemented at least partially in hardware of the audio source device 102.

In one or more implementations, the sound leak mitigation module 202 and/or the live transcription module 206 include independent processing, memory, and/or logic components functioning as a computing and/or electronic device integrated with the audio source device 102. Alternatively, or in addition, the sound leak mitigation module 202 and/or the live transcription module 206 can be implemented in software, in hardware, or as a combination of software and hardware components. In this example, the sound leak mitigation module 202 and/or the live transcription module 206 are implemented as a software application or module, such as executable software instructions (e.g., computer-executable instructions) that are executable with a processor system of the audio source device 102 to implement the techniques and features described herein. As a software application or module, the sound leak mitigation module 202 and/or the live transcription module 206 can be stored on computer-readable storage memory (e.g., memory of a device), or in any other suitable memory device or electronic data storage implemented with the module(s). Alternatively, or in addition, the sound leak mitigation module 202 and/or the live transcription module 206 are implemented in firmware and/or at least partially in computer hardware. For example, at least part of the sound leak mitigation module 202 and/or the live transcription module 206 are executable by a computer processor, and/or at least part of the sound leak mitigation module 202 and/or the live transcription module 206 are implemented in logic circuitry.

The sound leak mitigation module 202 identifies the type of personal listening device 104 being used and adjusts the audio output accordingly to mitigate sound leakage from the personal listening device. The type of personal listening device 104 may be an open back, semi-open back, bone conduction, in-ear, on-ear, or closed back headphones, headpiece, or earbuds, all of which have varying levels of sound leakage. Other types of personal listening devices 104 are contemplated. The sound leak mitigation module 202 can reduce the volume of the audio output to compensate for the sound leakage characteristics of the personal listening device 104.

In implementations, the sound leakage characteristics of various personal listening device types can be stored in the sound leakage characteristic database 204. By determining the personal listening device type (e.g., by querying the sound leakage characteristic database 204), the sound leak mitigation module 202 can categorize the personal listening device 104 into a sound leakage category. The sound leakage category can be as simple as “most leaky” or “least leaky,” or a more fine-grained categorization using a multi-point scale (e.g., 1-5 or 1-10). Other categorization techniques are contemplated, such as a letter-based scale (A, B, C, D, or F) or the like. The sound leakage characteristic database 204 can store additional information, such as the manufacturer and model number of various personal listening devices 104.

In some implementations, the sound leak mitigation module 202 can also selectively enable the live transcription module 206 to provide the live transcription feature 132. The live transcription module 206 can be a standalone software application that can be initiated by the sound leak mitigation module 202 and executed by a processor the audio source device 102 to provide the live transcription feature 132. Alternatively, the live transcription module 206 can be built-in to an operating system of the audio source device 102. The live transcription module 206 may perform live transcription using local processing resources and/or may utilize external processing resources, such as a cloud-based live transcription service.

The sound leak mitigation architecture 200 also includes a device interface 208 that can be utilized to interface with a personal listening device 104. The device interface 208 can be a wired and/or wireless interface. Separate or combined interfaces for wired and wireless connectivity are also contemplated. The device interface 208 can be or can include a universal serial bus (USB) interface, which may utilize any generation of USB technology and any form factor of USB connector (e.g., USB-A or USB-C). The device interface 208 can be or can include an audio jack (e.g., 3.5 mm). The device interface 208 can be or can include a proprietary interface and/or can be or can include a BT interface, which may utilize any generation of BT technology. The sound leak mitigation architecture 200 can also include a network interface 210 that represents functionality (e.g., logic and/or hardware) enabling the audio source device 102 to interconnect and interface with networks, such as the communication network 116. For example, the network interface 210 enables wireless and/or wired connectivity of the audio source device 102 to the communication network 116.

The sound leak mitigation architecture 200 also includes a location module 212. The location module 212 can utilize any location determining technology to determine the location of the audio source device 102 and/or the personal listening device 104. For example, the location module 212 can triangulate the location of the audio source device 102 using location data received from the communication network 116 (e.g., embodied as a cellular network). The location module 212 may also include a GPS technology to determine the location of the audio source device 102 and/or the personal listening device 104. Cellular-assisted GPS is also contemplated. In some implementations, the location module 212 uses indoor positioning to establish the location of the audio source device 102 indoors. As such, the location module 212 can utilize proximity, WI-FI, ultra-wideband, acoustics, infrared, combinations thereof, and/or the like to determine the location of the audio source device 102 and/or the personal listening device 104 indoors.

The audio source device 102 can include and implement various device applications 214, such as any type of messaging application, email application, video communication application, cellular communication application, music/audio application, gaming application, media application, social platform applications, and/or any other of the many possible types of various device applications. Many of the device applications 214 have an associated application user interface that is generated and displayed for user interaction and viewing, such as on the display 124 of the audio source device 102. Generally, an application user interface, or any other type of video, image, graphic, and the like is digital image content that is displayable on the display 124 of the audio source device 102.

In this example, the audio source device 102 includes audio playback software 216, such as a type of device application 214. The audio playback software 216 can be any software capable of outputting audio, such as the audio 108, to the personal listening device 104. As noted above, in some implementations, the audio 108 is associated with communications, such as the private call 110. In these implementations, the audio playback software 216 can include client software for the communication platform 120. Other implementations of the audio playback software 216 include, but are not limited to, software that enable playback of the audio 108 associated with music, talk radio, podcasts, lectures, presentations, movies, videos, and the like. The audio playback software 216 can be standalone software or integrated into an operating system of the audio source device 102. For example, the audio playback software 216 may be a soft phone through which the user 112 can place and receive voice calls, such as the private call 110. The audio playback software 216 may be included as part of other software, such as video playback software (not shown).

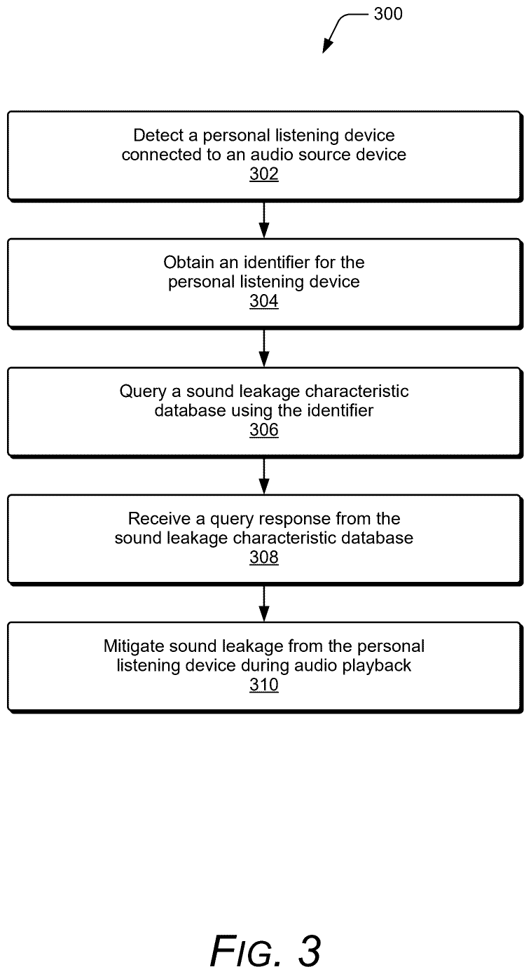

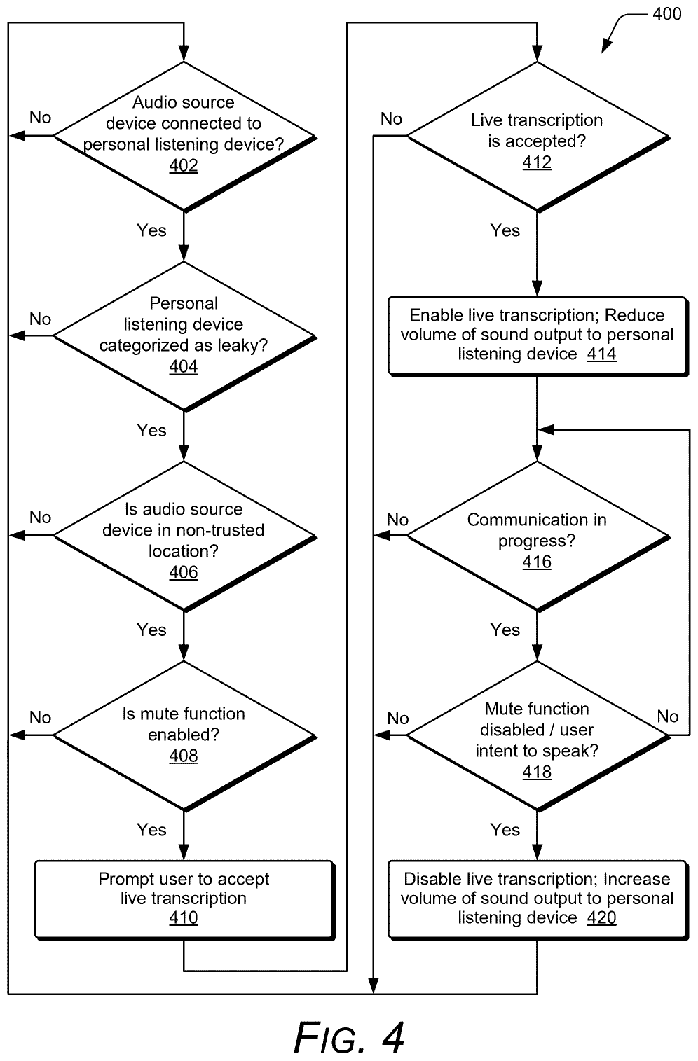

Example methods 300 and 400 are described with reference to respective FIGS. 3 and 4 in accordance with one or more implementations of sound leak mitigation for a personal listening device, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively, or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-Chip systems (SoCs), Complex Programmable Logic Devices (CPLDs), and the like.

FIG. 3 illustrates one or more example methods 300 for sound leak mitigation for a personal listening device, such as the personal listening device 104. The order in which the method 300 is described is not intended to be construed as a limitation, and any number or combination of the described method operations may be performed in any order to perform a method, or an alternate method.

At block 302, an audio source device is detected as having been connected to a personal listening device. For example, the audio source device 102 can connect to the personal listening device 104 via the device interface 208, and the sound leak mitigation module 202 detects that the audio source device 102 has connected to the personal listening device 104. In implementations, the connection 106 can be wired (e.g., via a 3.5 mm audio jack/cable or USB) and/or wireless (e.g., via BT) as described in more detail above. In some implementations, the audio source device 102 maintains a profile associated with the connection 106. For example, the audio source device 102 can utilize the profile to maintain one or more audio codecs used for communication between the audio source device 102 and the personal listening device 104. The profile can contain other information, such as volume settings, equalizer settings, balance and fader settings, and/or the like. For BT connections, specifically, the profile can be a BT profile that contains handshake information that enables the audio source device 102 and the personal listening device 104 to communicate via the BT protocol.

At block 304, an identifier for the personal listening device is obtained. For example, the sound leak mitigation module 202 obtains an identifier for, or associated with, the personal listening device 104. The identifier can be a generic identifier, such as to indicate “Personal Listening Device 1” or “headphones.” In some implementations, the sound leak mitigation module 202 may assign the generic identifier to the personal listening device 104 when the personal listening device is first connected to the audio source device 102. The generic identifier can be assigned from a group of predetermined generic identifiers, created on-the-fly, or a user may be prompted to provide a generic identifier or override one that has been assigned. In other implementations, the personal listening device 104 can share a unique identifier, which can be or can include numbers, letters, symbols, or any combination thereof. For wireless connections, such as BT, the identifier can be a unique BT address, which can be assigned to the personal listening device 104 by the manufacturer. For example, the unique BT address can be a unique 48-bit identifier display as 6 bytes written in hexadecimal form.

At block 306, a sound leakage characteristic database is queried to determine the sound leakage characteristics of the personal listening device. For example, the sound leak mitigation module 202 queries the sound leakage characteristic database 204 to determine the sound leakage characteristics of the personal listening device 104. The query can include the identifier obtained at block 304 as an input of the query. The sound leakage characteristic database 204 can include a mapping of identifiers to personal listening device 104 types. In some implementations, the sound leakage characteristic database 204 can be prepopulated with popular types of personal listening devices 104, such as an open back, semi-open back, bone conduction, in-ear, on-ear, or closed back types of headphones, headpieces, and/or earbuds. Each of these types can be associated with sound leakage characteristics. As one non-limiting example, in-ear and closed-back headphones can be categorized as “least leaky,” whereas open back, semi-open back, bone conduction, and on-ear can be categorized as “most leaky” or “leakiest.”

In some instances, the sound leakage characteristic database 204 is built as needed. For example, if the sound leak mitigation module 202 queries the sound leakage characteristic database 204 using the identifier and the sound leakage characteristic database 204 does not have an entry associated with that identifier, the sound leak mitigation module 202 can initiate to create a new entry using the identifier in the sound leakage characteristic database 204. In these instances, the sound leak mitigation module 202 may prompt a user to provide additional information about the personal listening device 104 being used. In other instances, the personal listening device 104 can provide this information.

In some implementations, instead of obtaining an identifier and querying the sound leakage characteristic database 204, the sound leak mitigation module 202 prompts a user to identify which type of personal listening device 104 was connected. For example, the sound leak mitigation module 202 may provide a list of the popular types with or without descriptions. The user can select the type that best describes the personal listening device 104 they are using. The sound leak mitigation module 202 can then associate, in the sound leakage characteristic database 204, the selected type with the identifier obtained at block 304.

In some implementations, the sound leakage characteristic database 204 may be provided as part of a service. The service can be updated as needed, updated according to a schedule, or periodically updated. In this manner, the sound leakage characteristic database 204 can maintain up-to-date entries for popular personal listening devices 104. The sound leakage characteristic database 204 can also be populated with testing data, which can be sourced from the manufacturer and/or independent lab tests. In some implementations, professional and/or customer reviews can be used to establish the sound leakage characteristics for a given personal listening device. For example, machine learning technologies can be used to search reviews and extract information related to the sound leakage characteristics.

At block 308, a query response is received from the sound leakage characteristic database. For example, the sound leak mitigation module 202 receives a query response from the sound leakage characteristic database 204. The query response can contain sound leakage characteristics that are stored in the sound leakage characteristic database 204 in association with the identifier obtained at block 304 and provided to the sound leakage characteristic database 204 as part of the query at block 306. Alternatively, if no entry exists, a user can be prompted to provide the personal listening device 104 type to use a baseline of the likely sound leakage characteristics.

At block 310, the sound leakage from the personal listening device is mitigated based on the sound leakage characteristics of the personal listening device. For example, the sound leak mitigation module 202 mitigates the sound leakage from the personal listening device during the audio playback. In implementations, the sound leak mitigation module 202 reduces the volume of the audio 108 to counteract the sound leakage according to the sound leakage characteristics. Additionally, in some implementations, the sound leak mitigation module 202 instructs the live transcription module 206 to transcribe the audio 108 and present the transcribed text 134 to the user 112 via the display 124 of the audio source device 102.

FIG. 4 illustrates one or more example methods 400 for sound leak mitigation for a personal listening device, such as the personal listening device 104. The order in which the method is described is not intended to be construed as a limitation, and any number or combination of the described method operations may be performed in any order to perform a method, or an alternate method.

At block 402, the sound leak mitigation module 202 determines if the audio source device 102 is connected to the personal listening device 104. For example, the sound leak mitigation module 202 monitors the device interface 208 to determine that the audio source device 102 is connected to the personal listening device 104. If the audio source device 102 is not connected to the personal listening device 104, the method 400 returns to block 402 and the sound leak mitigation module 202 continues to monitor the device interface 208.

If the audio source device 102 is determined to be connected to the personal listening device 104 (at block 402), then at block 404, the sound leak mitigation module 202 determines if the personal listening device 104 is categorized as leaky. The sound leak mitigation module 202 can determine if the personal listening device 104 is categorized as leaky using the method 300 described above, and particularly blocks 304, 306, and 308. Alternatively, the sound leak mitigation module 202 can receive input from a user that categorizes the personal listening device 104 as leaky. This can be beneficial for users who are particularly sensitive to the implications of sound leakage, such as to override a determination made by the sound leak mitigation module 202. If the sound leak mitigation module 202 determines that the personal listening device 104 is not categorized as leaky (e.g., least leaky, such as an in-ear or closed-back headphone), the method 400 returns to block 402 and continues as described above.

If the personal listening device 104 is categorized as leaky (e.g., most leaky or leakiest, such as open back headphones) (at block 404), then at block 406, the sound leak mitigation module 202 determines if the audio source device 102 is in a non-trusted location. For example, the sound leak mitigation module 202 requests a current location of the audio source device 102 from the location module 212. The location module 212 can return the current location and the sound leak mitigation module 202 can compare the current location to a list of trusted locations (or a list of non-trusted locations in alternative implementations). If the current location is not in the list of trusted locations, the method 400 returns to block 402 and the method 4 proceeds as described above.

In some implementations, the sound leak mitigation module 202 can request (e.g., via a prompt presented on the display 124 of the audio source device 102) a user whether or not to trust the current location in which the audio source device is located. The answers the user provides over time can be used to populate the list of trusted locations. The sound leak mitigation module 202 may infer what constitutes a trusted location. For example, a location that is stored in an address book may be considered a trusted location if accompanied by a name such as “Home” or “Work.” Other locations known to be public places, such as a coffee shop, library, or restaurant may be automatically considered non-trusted unless otherwise approved. Other implementations of this trusted or non-trusted location concept are contemplated.

If the current location of the audio source device 102 is in a non-trusted location (at block 406), then at block 408, the sound leak mitigation module 202 determines if a mute function is enabled. For example, the sound leak mitigation module 202 can query the operating system to determine mute function status (enabled or disabled). The user may manually enable or disable the mute function from time-to-time. Similarly, the audio playback software 216 may automatically enable or disable the mute function, such as disabling the mute function when the user speaks or enabling the mute function when the user is silent. The audio playback software 216 may also include settings for when the mute function is enabled and when the mute function is disabled. If the mute function is not enabled, the method 400 returns to block 402 and the method proceeds as described above. If the mute function is enabled, the method 400 proceeds to block 410.

If the mute function is enabled (at block 408), then at block 410, the sound leak mitigation module 202 prompts the user 112 to accept a live transcription of the audio 108. The prompt can be an audio prompt presented to the user via the personal listening device 104 and/or a speaker of the audio source device 102. Alternatively, or additionally, the prompt can be a visual prompt presented to the user via the display 124 of the audio source device 102. At block 412, the sound leak mitigation module 202 determines if the user accepted the live transcription. For example, the sound leak mitigation module 202 receives a user input to accept the live transcription via an input to the audio source device 102. The input can be a verbal acceptance from the user, which can be captured via a microphone of the audio source device 102 and/or a microphone of the personal listening device 104. The input can be soft button or hard button press assigned to indicate the user's acceptance or not of the live transcription. If the user does not accept the live transcription, the method 400 returns to block 402 and the method continues as described above.

If the sound leak mitigation module 202 determines that live transcription has been accepted (at block 412), then at block 414, the sound leak mitigation module 202 enables live transcription via the live transcription module 206. The live transcription module 206 can then begin transcribing the audio 108 into the transcribed text 134. Also at block 414, the sound leak mitigation module 202 reduces the volume of the sound output to the personal listening device 104. The sound leak mitigation module 202 reduces the volume based on how leaky the personal listening device 104 is (based on a determination or category of the sound leakage characteristics, as described above). For example, the volume of sound output to an open back headphone may be lower than the sound output to a semi-open back headphone. The volume can be reduced by a percentage of a maximum volume, such as indicated by the volume level indicator 130. The volume alternatively can be reduced by a specific number of decibels.

At block 416, the sound leak mitigation module 202 determines if a communication is in progress (e.g., whether or not the private call 110 is in progress). The private call 110 can include a video or audio conference meeting being executed on the personal listening device 104. If a communication is not in progress, such as when the private call 110 has ended, the method 400 returns to block 402 and the method 400 proceeds as described above.

If a communication is in progress (at block 416), then at block 418, the sound leak mitigation module 202 determines if the mute function is disabled or if the user is intent to speak. If the mute function remains enabled or the user is not intent to speak, the method 400 returns to block 416 and the method proceeds as described above. If the mute function is disabled or the user is intent to speak (at block 418), then at block 420, the sound leak mitigation module 202 disables transcription via the live transcription module 206. The live transcription module 206 can then end transcribing the audio 108 into the transcribed text 134, and the sound leak mitigation module 202 can initiate to increase the volume of sound output to the personal listening device 104. The method 400 can then return to block 402 and proceed as described above.

FIG. 5 illustrates various components of an example device 500, which can implement aspects of the techniques and features for sound leak mitigation for a personal listening device, as described herein. The example device 500 may be implemented as any of the devices described with reference to the previous FIGS. 1-4, such as any type of a wireless device, mobile device, mobile phone, flip phone, client device, companion device, display device, tablet, computing, communication, entertainment, gaming, media playback, and/or any other type of computing, consumer, and/or electronic device. For example, the audio source device 102 described with reference to FIGS. 1-4 may be implemented as the example device 500.

The example device 500 can include various, different communication devices 502 that enable wired and/or wireless communication of device data 504 with other devices, such as the personal listening device 104. The device data 504 can include any of the various device data and content that is generated, processed, determined, received, stored, and/or communicated from one computing device to another. Generally, the device data 504 can include any form of audio (e.g., the audio 108), video, image, graphics, and/or electronic data that is generated by applications executing on a device. The communication devices 502 can also include transceivers for cellular phone communication and/or for any type of network data communication, such as with the communication network(s) 116.

The example device 500 can also include various, different types of data input/output (I/O) interfaces 506, such as data network interfaces that provide connection and/or communication links between the devices, data networks, and other devices. The data I/O interfaces 506 may be used to couple the device 500 to any type of components, peripherals, and/or accessory devices, such as a computer input device that may be integrated with the example device 500 or the personal listening device 104. The I/O interfaces 506 may also include data input ports via which any type of data, information, media content, communications, messages, and/or inputs may be received, such as user inputs to the device 500, as well as any type of audio, video, image, graphics, and/or electronic data received from any content and/or data source.

The example device 500 includes a processor system 508 of one or more processors (e.g., any of microprocessors, controllers, and the like) and/or a processor and memory system implemented as a system-on-chip (SoC) that processes computer-executable instructions. The processor system 508 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 510. The example device 500 may also include any type of a system bus or other data and command transfer system that couples the various components within the device 500. A system bus can include any one or combination of different bus structures and architectures, as well as control and data lines.

The example device 500 also includes memory and/or memory devices 512 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 512 include volatile memory and non-volatile memory, fixed and removable media devices, and any suitable memory device or electronic data storage that maintains data for computing device access. The memory devices 512 can include various implementations of random-access memory (RAM), read-only memory (ROM), flash memory, and other types of storage media in various memory device configurations. The example device 500 may also include a mass storage media device. In implementations, the memory devices 512 can provide data storage for the sound leakage characteristic database 204 on the example device 500 (e.g., such as when implemented as the audio source device 102).

The memory devices 512 (e.g., as computer-readable storage memory) provide data storage mechanisms, such as to store the device data 504, other types of information and/or electronic data, and various device applications 514 (e.g., software applications and/or modules). For example, an operating system 516 may be maintained as software instructions with a memory device 512 and executed by the processor system 508 as a software application. The device applications 514 may also include a device manager, such as any form of a control application, software application, signal-processing and control module, code that is specific to a particular device, a hardware abstraction layer for a particular device, and so on. In implementations, the audio playback software 216 is an example of a device application 514.

In this example, the device 500 includes a sound leak mitigation module 518 that implements various aspects of the features and techniques described herein. The sound leak mitigation module 518, which may include the live transcription module 206, may be implemented with hardware components and/or in software as one of the device applications 514, such as when the example device 500 is implemented as the audio source device 102 described with reference to FIGS. 1-4. An example of the sound leak mitigation module 518 is the sound leak mitigation module 202 implemented by the audio source device 102, such as a software application and/or as hardware components in the audio source device. In implementations, the sound leak mitigation module 518 may include independent processing, memory, and logic components as a computing and/or electronic device integrated with the example device 500.

The example device 500 can also include a microphone 520 (e.g., to capture an audio recording of the user 112) and/or camera devices 522 (e.g., to capture video images of a user during a call, such as the private call 110), as well as motion sensors 524, such as may be implemented as components of an inertial measurement unit (IMU). The motion sensors 524 may be implemented with various sensors, such as a gyroscope, an accelerometer, and/or other types of motion sensors to sense motion of the device. The motion sensors 524 can generate sensor data vectors having three-dimensional parameters (e.g., rotational vectors in x, y, and z-axis coordinates) indicating location, position, acceleration, rotational speed, and/or orientation of the device 500. In this manner, the device 500 embodied as the audio source device 102 can use the motion sensors 524 as input to the sound leak mitigation module 202 to enable or disable the sound leak mitigation module 202 or certain features thereof. For example, the motion sensors 524 can detect when the device 500 is flat on a surface (e.g., a table) or being held in a user's hand. Other orientations of the device 500 can be determined by the motion sensors 524.

The example device 500 can also include one or more power sources 526, such as when the device is implemented as a wireless device and/or mobile device. The power sources may include a charging and/or power system, and may be implemented as a flexible strip battery, a rechargeable battery, a charged super-capacitor, and/or any other type of active or passive power source. The example device 500 can also include an audio and/or video processing system 528 that generates audio data for an audio system 530 and/or generates display data for a display system 532. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 500. Alternatively, the audio system and/or the display system are external, peripheral components to the example device.

Although implementations for sound leak mitigation for a personal listening device have been described in language specific to features and/or methods, the appended claims are not necessarily limited to the specific features or methods described. Rather, the specific features and methods are disclosed as example implementations for sound leak mitigation for a personal listening device, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to an audio source device, comprising a device interface to connect the audio source device to a personal listening device for audio playback; a sound leak mitigation module implemented at least partially in hardware and configured to: detect the personal listening device connected to the audio source device via the device interface; determine that the personal listening device exhibits sound leakage during the audio playback; and mitigate the sound leakage from the personal listening device during the audio playback.

Alternatively, or in addition to the above-described audio source device, any one or combination of: the sound leak mitigation module is configured to obtain an identifier for the personal listening device, the identifier indicating at least one of a type of the personal listening device, a manufacturer of the personal listening device, or a model of the personal listening device. The type of the personal listening device includes at least one of an open back headphone, a semi-open back headphone, a bone conduction headphone, an on-ear headphone, an in-ear headphone, or a closed-back headphone. To determine that the personal listening device exhibits the sound leakage during the audio playback, the sound leak mitigation module is configured to: query a sound leakage characteristic database using the identifier; and receive a query response that includes an indication of whether the personal listening device exhibits the sound leakage during the audio playback. The indication of whether the personal listening device exhibits the sound leakage during the audio playback comprises a sound leakage category. To mitigate the sound leakage from the personal listening device during the audio playback, the sound leak mitigation module is configured to reduce a volume of the audio playback to compensate for the sound leakage. To mitigate the sound leakage from the personal listening device during the audio playback, the sound leak mitigation module is configured to selectively enable a transcription function to transcribe the audio playback into text to compensate for the sound leakage.

In some aspects, the techniques described herein relate to a method, comprising: determining that a personal listening device exhibits sound leakage during audio playback of audio received from an audio source; and mitigating the sound leakage from the personal listening device during the audio playback.

Alternatively, or in addition to the above-described method, any one or combination of: the method further comprising obtaining an identifier for the personal listening device, the identifier indicating at least one of a type of the personal listening device, a manufacturer of the personal listening device, or a model of the personal listening device. The type of the personal listening device includes at least one of an open back headphone, a semi-open back headphone, a bone conduction headphone, an on-ear headphone, an in-ear headphone, or a closed-back headphone. The determining that the personal listening device exhibits the sound leakage during the audio playback comprises: querying a sound leakage characteristic database using the identifier; and receiving a query response that includes an indication of whether the personal listening device exhibits the sound leakage during audio playback. The indication of whether the personal listening device exhibits the sound leakage during the audio playback comprises a sound leakage category. The mitigating the sound leakage from the personal listening device during the audio playback comprises reducing a volume of the audio playback to compensate for the sound leakage. The mitigating the sound leakage from the personal listening device during the audio playback comprises selectively enabling a transcription function to transcribe the audio playback into text to compensate for the sound leakage.

In some aspects, the techniques described herein relate to a system, comprising: a mobile device connected to a personal listening device via a device interface; a sound leak mitigation module configured to: determine that the personal listening device exhibits sound leakage during audio playback; and mitigate the sound leakage from the personal listening device during the audio playback.

Alternatively, or in addition to the above-described system, any one or combination of: the mobile device is configured to connect to a communication platform that hosts an audio call between the mobile device and one or more communication devices; and the sound leak mitigation module is configured to mitigate the sound leakage of the audio call from the personal listening device. To mitigate the sound leakage from the personal listening device during the audio playback, the sound leak mitigation module is configured to reduce a volume of the audio playback to compensate for the sound leakage. To mitigate the sound leakage from the personal listening device during the audio playback, the sound leak mitigation module is configured to transcribe at least a portion of the audio playback for presentation on a display device of the mobile device. To mitigate the sound leakage from the personal listening device during the audio playback, the sound leak mitigation module is configured to transcribe at least a portion of the audio playback for presentation on a display device of the mobile device. The sound leak mitigation module is configured to mitigate the sound leakage from the personal listening device during the audio playback based at least in part on a sound leakage characteristic of the personal listening device.

In some aspects, the techniques described herein relate to a system, wherein the audio source device is further configured to connect to a communication platform that hosts a call between the audio source device and one or more other devices, and wherein the call includes the audio.

1. An audio source device, comprising:
a device interface to connect the audio source device to a personal listening device for audio playback;
a sound leak mitigation module implemented at least partially in hardware and configured to:
detect the personal listening device connected to the audio source device via the device interface;
determine that the personal listening device exhibits sound leakage during the audio playback; and
mitigate the sound leakage from the personal listening device during the audio playback.

2. The audio source device of claim 1, wherein the sound leak mitigation module is configured to obtain an identifier for the personal listening device, the identifier indicating at least one of a type of the personal listening device, a manufacturer of the personal listening device, or a model of the personal listening device.

3. The audio source device of claim 2, wherein the type of the personal listening device includes at least one of an open back headphone, a semi-open back headphone, a bone conduction headphone, an on-ear headphone, an in-ear headphone, or a closed-back headphone.

4. The audio source device of claim 2, wherein, to determine that the personal listening device exhibits the sound leakage during the audio playback, the sound leak mitigation module is configured to:
query a sound leakage characteristic database using the identifier; and
receive a query response that includes an indication of whether the personal listening device exhibits the sound leakage during the audio playback.

5. The audio source device of claim 4, wherein the indication of whether the personal listening device exhibits the sound leakage during the audio playback comprises a sound leakage category.

6. The audio source device of claim 1, wherein to mitigate the sound leakage from the personal listening device during the audio playback, the sound leak mitigation module is configured to reduce a volume of the audio playback to compensate for the sound leakage.

7. The audio source device of claim 1, wherein to mitigate the sound leakage from the personal listening device during the audio playback, the sound leak mitigation module is configured to selectively enable a transcription function to transcribe the audio playback into text to compensate for the sound leakage.

8. A method, comprising:
determining that a personal listening device exhibits sound leakage during audio playback of audio received from an audio source device; and
mitigating the sound leakage from the personal listening device during the audio playback.

9. The method of claim 8, further comprising obtaining an identifier for the personal listening device, the identifier indicating at least one of a type of the personal listening device, a manufacturer of the personal listening device, or a model of the personal listening device.

10. The method of claim 9, wherein the type of the personal listening device includes at least one of an open back headphone, a semi-open back headphone, a bone conduction headphone, an on-ear headphone, an in-ear headphone, or a closed-back headphone.

11. The method of claim 8, wherein the determining that the personal listening device exhibits the sound leakage during the audio playback comprises:
querying a sound leakage characteristic database using an identifier associated with the personal listening device; and
receiving a query response that includes an indication of whether the personal listening device exhibits the sound leakage during the audio playback.

12. The method of claim 11, wherein the indication of whether the personal listening device exhibits the sound leakage during the audio playback comprises a sound leakage category.

13. The method of claim 8, wherein the mitigating the sound leakage from the personal listening device during the audio playback comprises reducing a volume of the audio playback to compensate for the sound leakage.

14. The method of claim 8, wherein the mitigating the sound leakage from the personal listening device during the audio playback comprises selectively enabling a transcription function to transcribe the audio playback into text to compensate for the sound leakage.

15. A system, comprising:
a mobile device connected to a personal listening device via a device interface;
a sound leak mitigation module configured to:
determine that the personal listening device exhibits sound leakage during audio playback; and
mitigate the sound leakage from the personal listening device during the audio playback.

16. The system of claim 15, wherein:
the mobile device is configured to connect to a communication platform that hosts an audio call between the mobile device and one or more communication devices; and
the sound leak mitigation module is configured to mitigate the sound leakage of the audio call from the personal listening device.

17. The system of claim 15, wherein, to mitigate the sound leakage from the personal listening device during the audio playback, the sound leak mitigation module is configured to reduce a volume of the audio playback to compensate for the sound leakage.

18. The system of claim 15, wherein, to mitigate the sound leakage from the personal listening device during the audio playback, the sound leak mitigation module is configured to transcribe at least a portion of the audio playback for presentation on a display device of the mobile device.

19. The system of claim 15, wherein, to mitigate the sound leakage from the personal listening device during the audio playback, the sound leak mitigation module is configured to transcribe at least a portion of the audio playback for presentation on a display device of the mobile device.

20. The system of claim 15, wherein the sound leak mitigation module is configured to mitigate the sound leakage from the personal listening device during the audio playback based at least in part on a sound leakage characteristic of the personal listening device.
